(19) United States
(12) Patent Application Publication
(10) Pub. No.: US 2011/0292187 A1
(43) Pub. Date: Dec. 1, 2011

(54) 3D Display Control Device and Method Thereof

(75) Inventors: Jiunn-Kuang Chen, Hsinchu Hsien (TW); Chieh-huang Tu, Hsinchu Hsien (TW); Hung-Yi Lin, Hsinchu Hsien (TW)

(73) Assignee: MSTAR SEMICONDUCTOR, INC., Hsinchu Hsien (TW)

(21) Appl. No.: 13/114,259

(22) Filed: May 24, 2011

Related U.S. Application Data
(60) Provisional application No. 61/347,828, filed on May 25, 2010.

(51) Int. Cl. H04N 13/04

(52) U.S. Cl. 348/51; 348/E13.059

(57) ABSTRACT

A three-dimensional (3D) display control device generates a suitable and fixed output timing signal for a 3D display panel. Regardless of input 3D video format, the 3D display control device maintains a stable 3D display quality. The 3D display control device includes a receiving unit, for receiving 3D video data and a corresponding input timing signal from a 3D video source; and a timing control unit, for generating a group of output timing signals for displaying the 3D video data to the 3D display panel according to the input timing signal. The group of output timing signals corresponds to a group of output timing parameters for the 3D display panel, and the group of output timing parameters is independent from a 3D video format of the 3D video data.

### CROSS REFERENCE TO RELATED PATENT APPLICATION

This patent application claims the benefit of U.S. provisional patent application No. 61/347,828 filed on May 25, 2010, the entirety of which is incorporated herein by reference.

### FIELD OF THE INVENTION

The present invention relates to three-dimensional (3D) display, and more particularly, to a 3D display control device and method thereof.

### BACKGROUND OF THE INVENTION

In the display technology field, 3D display has recently become one of most researched subjects. As a result, multiple 3D video formats have been developed, e.g., High-Definition Multimedia Interface (HDMI) 1.4a, DisplayPort 1.1a, Display Port 1.2, as well as other proprietary 3D formats. Different video formats have difference parameters such as resolutions, frame rates, frame packing patterns and other associated parameters. In order to support those different video formats, a 3D display device needs to be adjusted (and further fine-adjusted) correspondingly, e.g., an output timing parameter must be adjusted, so that the video formats are converted to video formats supported by the display device and display quality is maintained. However, since different 3D video formats may correspond to different adjustment implementations, it is a challenge for a manufacturer of 3D display devices to ensure that the 3D display devices are capable of playing of the multiple different 3D video formats.

### SUMMARY OF THE INVENTION

In view of the foregoing issues, one object of the present invention is to provide a 3D display control device and method thereof that is capable of generating an appropriate and fixed output timing signal regardless of the type of 3D video format inputted into a same 3D display panel, so as to maintain a stable 3D display quality as well as to reduce adjustments performed in connection with selected 3D video formats.

In an embodiment of the present invention, a 3D display control device comprises a receiving unit, for receiving an input timing signal from a 3D video source, with the input timing signal corresponding to a 3D video format of the 3D video source; and a timing generating unit, for generating a group of output timing signals for 3D display according to the input timing signal, with the group of output timing signals corresponding to a group of output timing parameters applicable to a 3D display panel, and the group of output timing parameters comprising a vertical timing interval, a horizontal timing interval, an output clock frequency and a 3D glass timing interval; wherein, the group of output timing parameters is independent from the 3D video format.

In another embodiment of the present invention, a 3D display control method comprises determining a group of output timing parameters applicable to a 3D display panel, with the group of output timing parameters comprising a vertical timing interval, a horizontal timing interval, an output clock frequency and a 3D glass timing interval; and generating a group of output timing signals corresponding to the group of output timing parameters according to an input timing signal provided by a 3D video source to perform 3D display, with the input timing signal corresponding to a 3D video format of the 3D video source; wherein, the group of output timing parameter is independent from the 3D video format.

The advantages and spirit related to the present invention can be further understood via the following detailed description and drawings.

### BRIEF DESCRIPTION OF THE DRAWINGS

FIG. 1 is a block diagram of a three-dimensional (3D) display control device in accordance with an embodiment of the present invention.

FIG. 2 is a schematic diagram of an output frame format conforming to a group of output timing parameters in accordance with an embodiment of the present invention.

FIG. 3 depicts timing of an output timing signal generated by a timing control unit illustrated in FIG. 1 in accordance with an embodiment of the present invention.

FIG. 4 is a block diagram of the timing control unit illustrated in FIG. 1 in accordance with an embodiment of the present invention.

FIG. 5A and FIG. 5B are schematic diagrams of the timing control unit illustrated in FIG. 4 under such situations that an output frame rate is different multiples of an input frame rate.

FIG. 6 is a flow chart of a 3D display control method in accordance with an embodiment of the present invention.

### DETAILED DESCRIPTION OF THE PREFERRED EMBODIMENT

According to an embodiment of the present invention, a 3D display control device and method thereof provides a group of predetermined output timing parameters for displaying 3D images to a 3D display device or panel. The group of parameters is optimized so as to make the 3D display device or panel provide stable and satisfactory display efficiency. Regardless of the format of 3D video data inputted from a 3D video source, the 3D display control device and method generates a corresponding output timing signal according to the group of predetermined output timing parameters, and performs appropriate processing on the received 3D video data, such as scaling, de-interlacing and frame unpacking, so that the 3D display device or panel displays the processed 3D video data according to the output timing signal. Since fixed output timing parameters are applied, regardless of the input format of the input 3D video, the 3D display device or panel can achieve an identical display effect. In addition, complexity and cost of product design and manufacture are reduced since only one type of output timing parameter is provided for different 3D video formats.

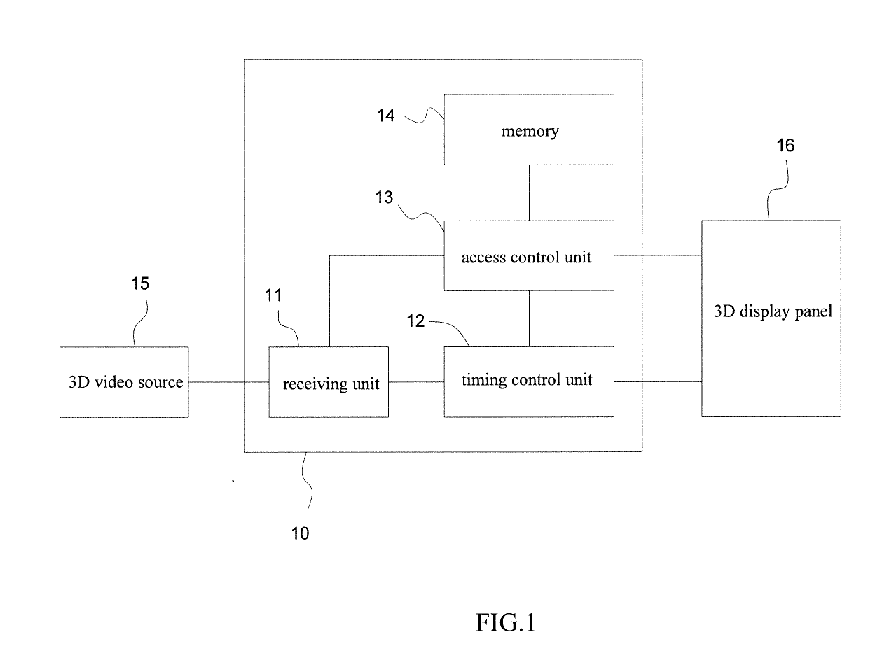

FIG. 1 shows a block diagram of a 3D display control device in accordance with an embodiment of the present invention. A 3D display control device 10 comprises a receiving unit 11, a timing control unit 12, an access control unit 13, and a memory 14. The receiving unit 11 receives 3D video data and a corresponding input timing signal from a 3D video source 15. The 3D video source can be a personal computer (PC), a laptop, a blue-ray player or a game console, for example. The receiving unit 11 identifies a 3D image format of the 3D video data, comprising a resolution, a frame rate, a frame packing manner, a scan manner (e.g., interlaced or progressive) and other associated parameters, which are regarded as indexes for subsequent operations of the timing control unit 12 and the access control unit 13.

The timing control unit 12 converts the input timing signal received by the receiving unit 11 into a group of output timing signals. The group of output timing signals is transmitted to a 3D display panel 16 for displaying the 3D video data. The group of output timing signals is defined to correspond to output characteristics of the 3D display panel 16, and is predetermined and independent from the 3D video format of the 3D video data. In other words, no matter what kind of the 3D video format is inputted from the video source 15, the group of output timing parameters remains unchanged, so that the output timing signals generated by the timing control unit 12 correspondingly stay unchanged so as to maintain the display quality of the 3D display panel 16.

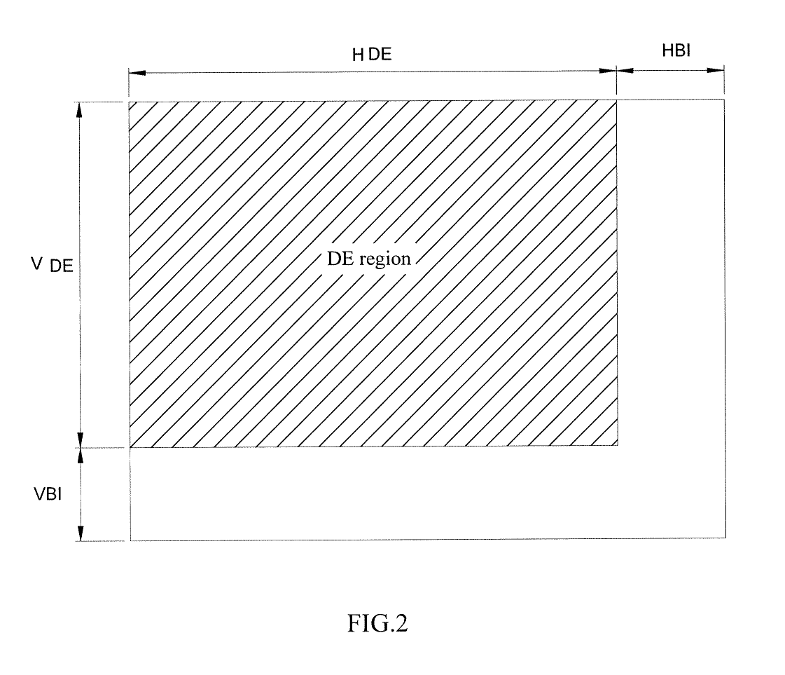

The group of fixed output timing parameters comprises a panel resolution, a vertical blanking interval (VBI), a horizontal blanking interval (HBI), and an output clock parameter. The panel resolution refers to a resolution of a panel visible region, e.g., 1920×1080 (i.e., a resolution of the Full HD specification) means that there are 1080 scan lines, and each can line has 1920 pixels. The VBI and HBI respectively define blanking intervals in a vertical direction and in a horizontal direction of an output frame. The VBI is defined as the number of scan lines, and the HBI is defined as the number of pixels. Therefore, a format of the output frame is defined according to the panel resolution, the HBI and the VBI. Referring to FIG. 2, a data enable (DE) region is defined in which valid data of the output frame corresponds to a panel visible region. An output clock that is a clock signal for outputting a pixel is referred to as an output pixel clock. An output clock parameter is an output clock frequency or an output clock period—the former is the number of pixels outputted per unit time and the latter is a time cost for outputting a pixel, and each of them is the reciprocal of the other. Therefore, when the panel resolution is H_{DE}×V_{DE}, and the output clock period is T, Formula 1 is calculated as:

An output time of one output frame=a total pixel number of the output frame×T=a horizontal pixel number Hₜₒₜₐₗ×a vertical san line number Vₜₒₜₐₗ×T=(H_{DE}+HBI)×(V_{DE}+VBI)×T

Since the output frame rate is the reciprocal of the output time of the output frame, in the event that the group of output timing parameters is fixed, the output frame rate is also fixed. Therefore, in another embodiment, the output clock parameter of the group of output timing parameters is replaced by the output frame rate, and is deduced from inputting the output frame rate of the group of output timing parameters, the panel resolution H_{DE}×V_{DE}, the VBI, the HBI, the output clock cycle T into the Formula 1.

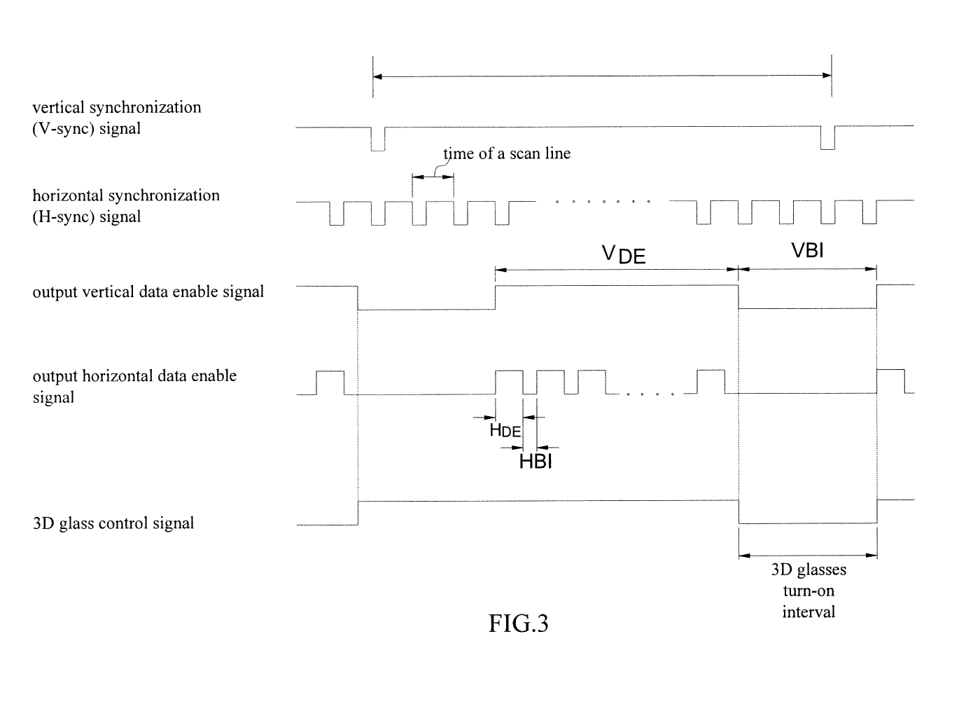

The timing control unit 12 generates a group of output timing signals corresponding to the group of output timing parameters, so that the 3D display panel 16 can perform 3D display according to the foregoing group of output timing parameters. In an embodiment, the group of output timing signals comprises an output clock signal, a vertical synchronization (V-sync) signal, a horizontal synchronization (H-sync) signal, an output vertical data enable signal and an output horizontal data enable signal. Referring to FIG. 3, the frequency of the output V-sync signal and the output vertical data enable signal is the output frame rate (the period, i.e., a time for outputting one frame, is the reciprocal of the output frame rate). The frequency of the output H-sync signal is calculated as: the output frame rate×(H_{DE}+HBI) (the period, i.e., a time of a scan line, is the reciprocal of the frequency). The timing of the output vertical data enable signal corresponds to the foregoing output timing parameters V_{DE} and VBI, and the timing of the output horizontal data enable signal corresponds to the foregoing output timing parameters H_{DE} and HBI.

Since the abovementioned group of output timing parameters is fixed, the 3D display panel 16 displays the output frame by a fixed output frame rate, and each output frame (having a format as shown in FIG. 2) has a fixed DE region, a fixed VBI and an fixed HBI. Therefore, with respect to the 3D display panel 16, regardless of the 3D video format provided by the 3D video source 15, the timing control unit 12 generates corresponding output timing signals according to the group of output timing parameters. Accordingly, the 3D display panel 16 not only offers stable 3D display format and efficiency, but the display panel 16 is also capable of determining appropriate output timing parameters according to different 3D video formats. Therefore, time and cost for applying different 3D video formats is reduced.

In an embodiment, when the 3D display panel 16 performs 3D display in connection with 3D shutter glasses, the abovementioned group of output timing parameters further comprises a 3D glasses turn-on interval for determining a turn-on interval for the pair of 3D shutter glasses. The output timing signals generated by the timing control unit 12 further comprise a 3D glass control signal corresponding to the 3D glass turn-on interval. Since the 3D display panel 16 alternately outputs a left frame and a right frame, the 3D shutter glasses alternately turn on the left glass and the right glass to associate with the output manner of the 3D display panel 16, so as to achieve an effect that a left-eye of a user observes the left frame and a right-eye of the user observes the right frame. The foregoing 3D glass turn-on interval and the corresponding 3D glass control signal are applied for controlling when and how much time the 3D shutter glasses is turned on. When the 3D display panel 16 displays an output frame, a VBI begins to be displayed after the display of a data enable region of the output frame. Likewise, a data enable region of a next output frame only begins to be displayed after the display of the VBI. As a result, it is appropriate to define the VBI as the 3D glass turn-on interval. Accordingly, when the 3D shutter glasses is turned on at the period of VBI, regardless of whether the output frame is the left frame or the right frame, the user can observe the completely-displayed accurate data enable region since no DE is displayed at the period of VBI. According to the 3D glass control signal shown in FIG. 3, it shows that the corresponding 3D glass turn-on interval is equal to the VBI. It is to be noted that, the 3D glass turn-on interval can be defined slightly longer than (or shorter than) the VBI to provide a proper tolerance interval.

The foregoing 3D glass control signal is transmitted by an infrared (IR) emitter (not shown) coupled to the timing control unit 12 to the 3D shutter glasses so as to control the glasses to turn on/off. When the 3D video source 15 is a PC or other type of computers having a graphic card or a graphic chip, the timing control unit 12 transmits the 3D glass control signal to the graphic card or the graphic chip via an interface, e.g., a display data channel (DDC), and the graphic card or the graphic chip controls the pair of 3D glasses to turn on/off according to the 3D glass control signal. In another embodiment, the 3D glass control signal is transmitted to the 3D display panel, which controls the 3D glasses to turn on/off according to the 3D glass control signal.

Operations of the access control unit 13 are described below. The receiving unit 11 identifies the format of the received 3D video data, comprising the resolution, the frame packing manner, a scan manner (interlaced or progressive), and the like. The frame packing manner is a manner about how to pack a left frame and a right frame into a single frame. The frame packing manner can be implemented through a side-by-side or top-and-bottom packing manner. Another 3D video format adopts a frame sequential manner to directly transmit left frames and right frames in sequence without frame packing manner. The access control unit 13 accesses and processes the 3D video data according to the different 3D video formats identified by the receiving unit 11 to subsequently output the 3D video data to the 3D display panel 16 for displaying. More specifically, the access control unit 13 stores a plurality of left frames and right frames of the 3D video data into the memory 14 according to a left/right frame configuration manner (e.g., the frame packing or the frame sequential manner) of the 3D video format. For example, when the 3D video format adopts the frame packing manner, the access control unit 13 performs unpacking to unpack the received frame to a left frame and a right frame that are respectively stored into the memory 14. When the 3D video format adopts the frame sequential manner, the access control unit 13 directly stores the sequentially-received left and right frames into the memory 14. In addition, in one embodiment, the access control unit 13 comprises a video processing circuit. When the resolution of the received 3D video format is different from the panel resolution, the video processing circuit performs video scaling to convert the resolution of the received 3D video format into the panel resolution. When the received 3D video format adopts the interlaced scan manner, the video processing circuit performs de-interlacing to convert the interlaced scan manner to the progressive scan manner. Thereafter, the access control unit 13 alternately outputs the left and right frames to the 3D display panel 16 from the memory 14 according to the output timing signals generated by the timing control unit 12, so as to match with the sequence of the foregoing group of output timing parameters.

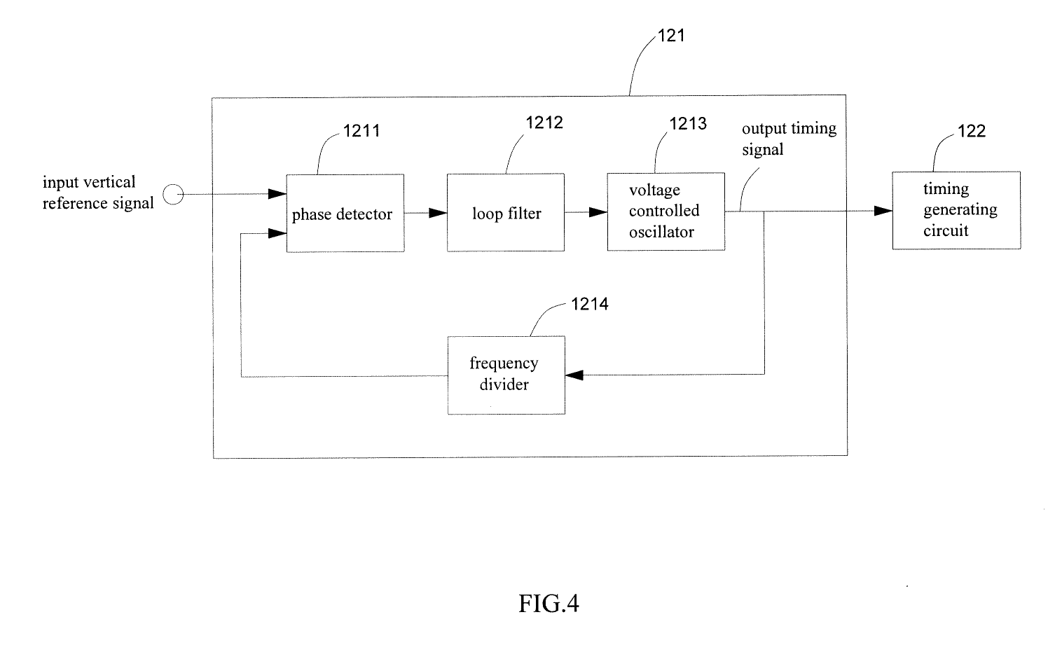

FIG. 4 is a block diagram of the timing control unit 12 shown in FIG. 1 in accordance with an embodiment of the present invention. The timing control unit 12 comprises a frame phased locked loop (PLL) 121 and a timing generating circuit 122. The frame PLL 121 converts an input timing signal, corresponding to an input frame rate, received by the receiving unit 11 to an output timing signal corresponding to an output frame rate according to a multiple relationship between an output frame rate (i.e., the number of frames displayed per time unit by the 3D display panel 16) and an input frame rate (i.e., the number of frames provided per time unit by the 3D video source 16). More specifically, referring to FIG. 4, the frame PLL 121 comprises a phase detector 1211, a loop filter 1212, a voltage controlled oscillator (VCO) 1213, and a frequency divider 1214. The phase detector 1211 receives the input timing signal from the receiving unit 11 as an input vertical reference signal, e.g., an input V-sync signal or an input vertical data enable signal having a frequency equal to the input frame rate. The frame PLL 121 generates the output timing signal as an output clock signal. The output clock signal is fed back to the phase detector 122 after it is frequency divided by the frequency divider 1214, so that the frequency (i.e., the input frame rate) of the input vertical reference signal is equal to a quotient obtained from dividing the frequency of the output clock with a divisor of the frequency divider 1214. Therefore, when the divisor of the frequency divider 1214 is N times of the total pixel number (i.e., equal to the horizontal pixel number Hₜₒₜₐₗ×the vertical scan line number Vₜₒₜₐₗ) of an output frame, Formula 2 is calculated as:

the input frame rate=the output clock frequency/(the total pixel number of the output frame×N);

In addition, it is deduced from Formula 1 that:

the output frame rate=1/(the output time of the output frame)=1/(the total pixel number of the output frame×the output clock period)=the output clock frequency/the total pixel number of the output frame.

In association with Formula 2, it is deduced that the output frame rate=the input frame rate×N, i.e., the output frame rate is N times the input frame rate. Therefore, when the input frame rate has a multiple relationship with the output frame rate of the foregoing group of output timing parameters, a corresponding output clock signal is generated from the frame PLL 121 by adjusting the divisor of the frequency divider 1214. The timing generating circuit 122 generates other output timing signals corresponding to the group of output timing parameters according to the output clock signal, e.g., the output V-sync signal, the output H-sync signal, the output vertical data enable signal, the output horizontal data enable signal and the 3D glass control signal as shown in FIG. 3.

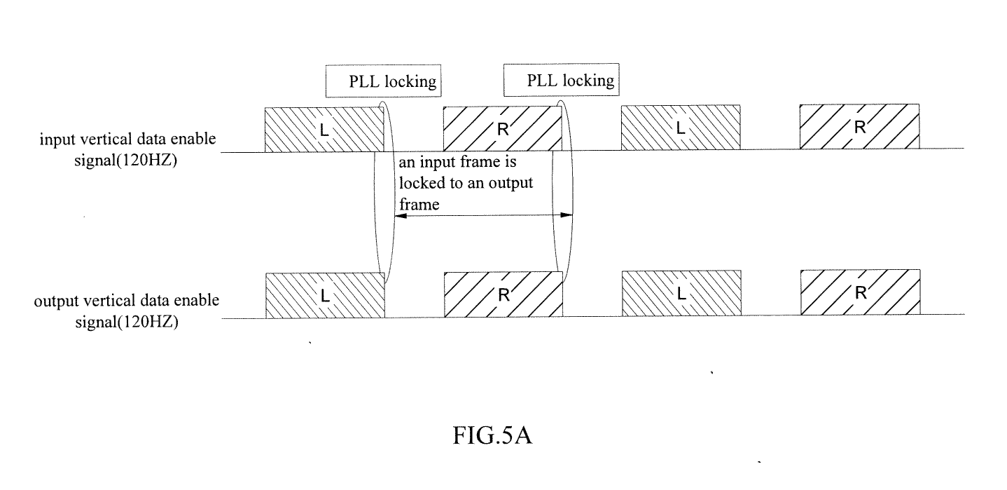

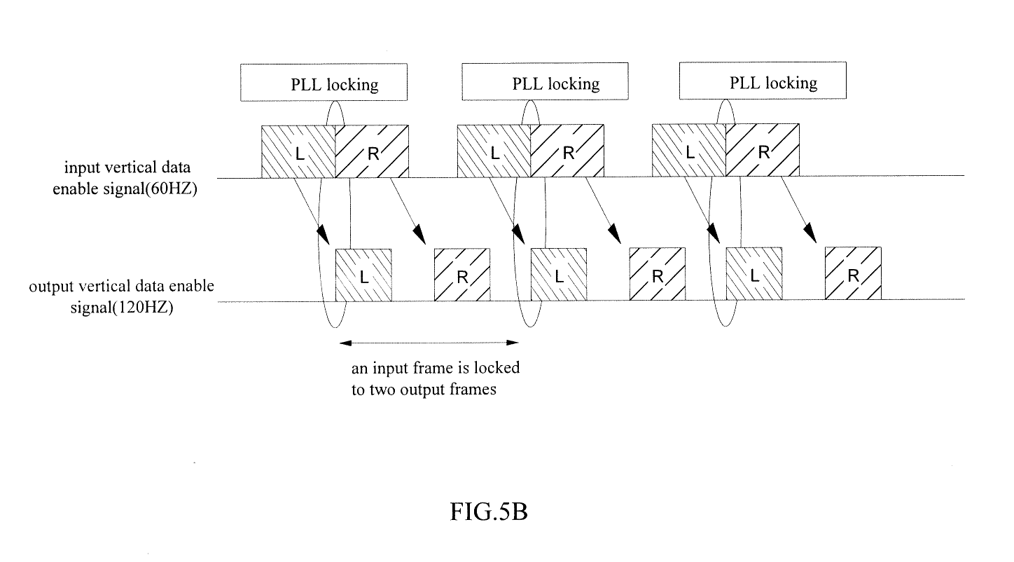

FIG. 5A and FIG. 5B are schematic diagrams of the timing control unit illustrated in FIG. 4 under the condition that an output frame rate has a value of different multiples of an input frame rate. In FIG. 5A and FIG. 5B, the output frame rate is 120 Hz, and the frame PLL 121 locks the output frame rate at N times of the input frame rate according to the input vertical data enable signal. For the sake of simplicity, only a relative timing relationship between the input vertical data enable signal (having the frequency equal to the input frame rate) and the output vertical data enable signal (having the frequency equal to the output frame rate) is illustrated in each of FIG. 5A and FIG. 5B. Referring to FIG. 5A, the input frame rate and the output frame rate are both 120 Hz (i.e., N=1), so that an input time of an input frame is equal to an output time of an output frame (i.e., an input frame is locked to an output frame). In addition, left and right frames are alternately sequentially inputted (i.e., the 3D video formats adopts the frame sequential manner), so that the output frames are outputted according to the original input sequence of the input frames. It is to be noted that, clock pulses (i.e., diagonal lines) of the input vertical data enable signal and the output vertical data enable signal respectively represent data enable regions of the input frames and output frames. Referring to FIG. 5B, the input frame rate is 60 Hz, and the output frame rate is maintained at 120 Hz (i.e., N=2), so that the input time of an input frame is equal to an output time of two output frames (i.e., one input frame is locked to two output frames). In addition, each input frame comprises one left frame and one right frame (taking the side-by-side packing manner as an example), so that the access control unit 13 unpacks the input frame into left and right frames. The left and right frames are stored in the memory 14 and outputted according to the sequence of the left and right frames and the output frame rate. A reference position (i.e., a position circled by an ellipse in FIG. 5B) on which the frame PLL 121 performs locking step is adjustable. For example, the reference position in FIG. 5A is located at a falling edge of the input vertical data enable signal, and the reference position in FIG. 5B is located at a central point (i.e., a cross region of the left and right frames) of the input vertical data enable signal. In addition, according to the present invention, the input frame rates are integer multiples of the output frame rates, e.g., when the input frame is 24 Hz, the output frame maintains at 120 Hz, i.e., N is equal to 5.

It is to be noted that the example that the input frame rate has an integer multiple relationship with the output frame rate should not be construed as limiting the present invention, i.e., the input frame rate may be a non-integer multiple of the output frame rate. For example, when the input frame rate is 48 Hz, the output frame rate is maintained at 120 Hz, i.e., N is equal to 2.5.

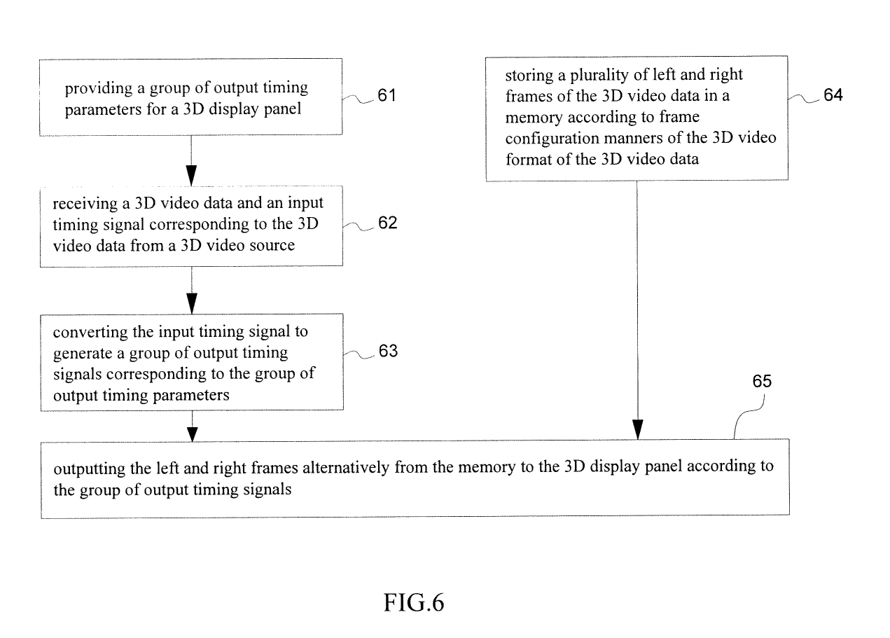

FIG. 6 is a flow chart of a 3D display control method in accordance with an embodiment of the present invention. In Step 61, a group of output timing parameters applicable to a 3D display panel is provided, comprising at least a resolution, a VBI, an HBI and an output clock reference. The output clock reference is an output clock frequency or an output clock period, and may be replaced by the output frame rate. The reason for such a relationship is explained in connection with the previously described Formula 1. In Step 62, 3D video data and an input timing signal corresponding to the 3D video data are received from a 3D video source. The group of output timing parameters provided in Step 61 is independent from a 3D video format of the 3D video data. In other words, the group of parameters stays unchanged, i.e., the group of parameters is also fixed when the 3D video format is changed.

In Step 63, the received input timing signal is converted to generate a group of output timing signals corresponding to the foregoing group of output timing parameters to the 3D display panel for displaying the 3D video data. In an embodiment, when the 3D display panel performs 3D display in connection with 3D shutter glasses, the group of output timing parameters further comprises a 3D glass turn-on interval for determining a turn-on interval for the 3D shutter glasses. The group of output timing signals generated in Step 63 comprises a 3D glass control signal, corresponding to the 3D glass turn-on interval, for controlling the 3D shutter glasses to turn on/off.

In Step 64, a plurality of left and right frames contained in the 3D video data are stored in a memory according to frame configuration manners of the 3D video format of the received 3D video data. In Step 65, according to the group of output timing signals, the left and right frames are alternately outputted from the memory to the 3D display panel for 3D display.

In an embodiment, the input timing signal received in Step 62 corresponds to an input vertical reference signal corresponding to the input frame rate of the 3D video source, e.g., an input V-sync signal or an input vertical data enable signal, and Step 63 comprises sub-steps (not shown) below.

In Sub-step 1, an output clock signal corresponding to the output clock parameter is generated according to a vertical scan line number and a horizontal pixel number of an output frame, a multiple relationship between the output frame rate and the input frame rate and the input vertical reference signal. The vertical scan line number and the horizontal pixel number are respectively determined according to VBIs and HBIs of the foregoing group of output timing parameters. This sub-step is performed by the frame PLL 121 shown in FIG. 4.

In Sub-step 2, other output timing signals are generated according to the output clock signal, e.g., an output V-sync signal, an output H-sync signal, an output vertical data enable signal and an output horizontal data enable signal. The output V-sync signal corresponds to the output frame rate, the output H-sync corresponds to the horizontal pixel number of the output frame, the output vertical data enable signal corresponds to the VBIs, and the output horizontal data enable signal corresponds to the HBIs.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A three-dimensional (3D) display control method, comprising:
providing a group of output timing parameters, comprising at least a vertical blanking interval (VBI), for a 3D display panel;
receiving 3D video data and an input timing signal corresponding to the 3D video data from a 3D video source; and
converting the input timing signal to generate a group of output timing signals to the 3D display panel for displaying the 3D video data;
wherein the group of output timing parameters is independent from a 3D video format of the 3D video data.

2. The method of claim 1, wherein the group of output timing parameters further comprises a 3D glass turn-on interval, and the group of output timing signals comprises a 3D glass control signal corresponding to the 3D glass turn-on interval, wherein the 3D glass turn-on interval is determined according to the VBI.

3. The method of claim 1, wherein the group of output timing parameters further comprises a horizontal blanking interval (HBI).

4. The method of claim 3, wherein the group of output timing parameters further comprises an output frame rate, the input timing signal corresponds to an input vertical reference signal of an input frame, and the step of generating the group of output timing signals comprises:
generating an output clock signal according to a vertical scan line number and a horizontal pixel number of an output frame, a multiple between the output frame rate and the input frame rate and the input vertical reference signal, wherein the vertical scan line number and the horizontal pixel number are respectively determined according to the VBI and the HBI.

5. The method of claim 4, wherein the step of generating the group of output timing signals further comprises:
generating an output vertical synchronization (V-sync) signal and an output horizontal synchronization (H-sync) signal according to the output clock signal, wherein the output V-sync signal corresponds to the output frame rate and the output H-sync signal corresponds to the horizontal pixel number.

6. The method of claim 4, wherein the step of generating the group of output timing signals further comprises:
generating an output vertical data enable signal and an output horizontal data enable signal according to the output clock signal, wherein the output vertical data enable signal corresponds to the VBI and the output horizontal data enable signal corresponds to the HBI.

7. The method of claim 4, wherein the step of generating the output clock signal is performed by a frame phase locked loop (PLL).

8. The method of claim 4, wherein the input vertical reference signal is an input V-sync signal or an input vertical data enable signal.

9. The method of claim 1, further comprising:
storing a plurality of left and right frames of the 3D video data into a memory according to frame configuration manners of the 3D video format; and
alternatively outputting the left and right frames to the 3D display panel from the memory according to the group of output timing signals.

10. A 3D display control device, comprising:
a receiving unit, configured to receive a 3D video data and an input timing signal corresponding to the 3D video data; and
a timing control unit, configured to convert the input timing signal to generate a group of output timing signals to a 3D display panel, the group of output timing signals corresponding to a group of output timing parameters for the 3D display panel and the group of output timing signals comprising at least one VBI;
wherein the group of output timing parameters is independent from a 3D video format of the 3D video data.

11. The 3D display control device of claim 10, wherein the group of output timing parameters further comprises a 3D glass turn-on interval, and the group of output timing signals comprises a 3D glass control signal corresponding to the 3D glass turn-on interval, wherein the 3D glass turn-on interval is determined according to the VBI.

12. The 3D display control device of claim 10, wherein the group of output timing parameters further comprises an HBI.

13. The 3D display control device of claim 12, wherein the group of output timing parameters further comprises an output frame rate, the input timing signal corresponds to an input vertical reference signal of an input frame rate, and the timing control unit comprises:
a frame PLL, configured to generate an output clock signal according to a vertical scan line number and a horizontal pixel number of an output frame, a multiple between the output frame rate and the input frame rate and the input vertical reference signal, wherein the vertical scan line number and the horizontal pixel number are respectively determined according to the VBI and the HBI.

14. The 3D display control device of claim 13, wherein the timing control unit further comprises:
a timing generating circuit, configured to generate an output V-sync signal and an output H-sync signal according to the output clock signal, wherein the output V-sync signal corresponds to the output frame rate and the output H-sync signal corresponds to the horizontal pixel number.

15. The 3D display control device of claim 13, wherein the timing control unit further comprises:
a timing generating circuit, configured to generate an output vertical data enable signal and an output vertical data enable signal according to the output clock signal, wherein the output vertical data enable signal corresponds to the VBI and the output horizontal data enable signal corresponds to the HBI.

16. The 3D display control device of claim 13, wherein the input vertical reference signal is an input V-synch signal or an input vertical data enable signal.

17. The 3D display control device of claim 10, further comprising:
a memory; and
an access control unit, configured to store a plurality of left and right frames of the 3D video data into the memory according to frame configuration manners of the 3D video format, and alternatively output the left and right frames to the 3D display panel from the memory according to the group of output timing signals.
